(19) United States
(12) Patent Application Publication
(10) Pub. No.: US 2011/0008716 A1
(43) Pub. Date: Jan. 13, 2011

(54) FUEL CELL INCLUDING SUPPORT HAVING MESH STRUCTURE

(76) Inventors: Jae Hyuk JANG, Gyunggi-do (KR); Hong Ryul Lee, Gyunggi-do (KR); Jae Hyoung Gil, Seoul (KR); Sung Han Kim, Seoul (KR); Eon Soo Lee, Gyeongsangbuk-do (KR); Jong Ho Chung, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/608,933

(22) Filed: Oct. 29, 2009

(30) Foreign Application Priority Data
Jul. 9, 2009 (KR) 10-2009-0062720
Aug. 4, 2009 (KR) 10-2009-0071631

(51) Int. Cl. H01M 8/10

(52) U.S. Cl. 429/532

(57) ABSTRACT

Disclosed is a solid oxide fuel cell, which includes a support having a mesh structure, an anode layer formed on an outer surface of the support, an electrolyte layer formed on an outer surface of the anode layer, and a cathode layer formed on an outer surface of the electrolyte layer and also which is lightweight and enables current collection.

### CROSS REFERENCE TO RELATED APPLICATIONS

This application claims the benefits of Korean Patent Application No. 10-2009-0062720, filed Jul. 9, 2009, entitled “Fuel cell having support of mesh structure”, and Korean Patent Application No. 10-2009-0071631, filed Aug. 4, 2009, entitled “Fuel cell comprising support of mesh structure”, which are hereby incorporated by reference in their entirety into this application.

### BACKGROUND OF THE INVENTION

1. Technical Field

The present invention relates to a fuel cell including a support having a mesh structure.

2. Description of the Related Art

A fuel cell is a device for directly converting the chemical energy of a fuel (hydrogen, LNG, LPT, etc.) and air into electric power and heat using an electrochemical reaction. Unlike conventional techniques for generating power including the combustion of fuel, generation of steam, operation of a turbine and operation of a power generator, the fuel cell has neither a combustion procedure nor an operator and is thus regarded as a novel power generation technique which results in high cell performance and no environmental problems.

FIG. 1 shows the principle behind the operation of a fuel cell.

With reference to FIG. 1, hydrogen (H₂) is supplied to an anode 1 and is then decomposed into protons (H⁺) and electrons (e⁻). The protons are transferred to a cathode 3 via an electrolyte 2. The electrons pass through an external circuit 4 causing current to flow. In the cathode 3, the protons and the electrons are combined with oxygen in the air, thus producing water. The chemical reaction of the fuel cell 10 is represented by Reaction 1 below.

Anode: H₂→2H⁺+2e⁻

Cathode: 1/2O₂+2H⁺+2e⁻→H₂O

Total Reaction: H₂+1/2O₂H₂O Reaction 1

Specifically, the fuel cell performs a cell function by passing the electrons separated in the anode 1 through the external circuit so that current is produced. Such a fuel cell 10 discharges air pollutants such as SOx and NOx in scarce amounts and generates a small amount of carbon dioxide and is thus a pollution-free power generator, and is also advantageous in terms of being low noise and without vibrations.

Examples of fuel cells include a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and so on. In particular, an SOFC enables high-efficiency power generation and composite power generation of coal gas-fuel cell-gas turbine and is variable in power generation capacity and is thus suitable for use in small and large power plants or as a distributed power source. Hence, the SOFC is essential for realizing a hydrogen-based society in the future.

However, actual use of the SOFC incurs the following problems which need to be solved.

First, the SOFC has poor durability and reliability. Because the SOFC is operated at high temperature, its performance is reduced due to a heat cycle. In particular, when the size of a unit cell is increased, durability and reliability of parts thereof may be drastically deteriorated due to the properties of ceramic used.

Second, the SOFC makes it difficult to collect current. According to conventional techniques, current is collected by using metal foam inside the unit cell and metal wires outside the unit cell. However, in such a structure, as the size of the cell is increased, the amount of expensive metal wires is increased, undesirably increasing the manufacturing cost and causing a complicated structure, thus making it difficult to realize mass production.

Third, the SOFC makes it difficult to connect the unit cell to a manifold. The manifold for supplying fuel such as hydrogen to the unit cell is made mainly of metal, to whereas the unit cell is made of ceramic. Thus, in order to connect the metal and the ceramic which are different from each other, a brazing process is used. However, the brazing process is disadvantageous because the unit cell may be clogged or it may be welded poorly, as this is dependent on the speed of increasing the voltage of the inductive coil in the welding procedure, the time that the voltage is maintained, and the cooling conditions following the brazing process.

Fourth, the SOFC is difficult to mold. According to conventional techniques, a ceramic molded body having a predetermined diameter is produced through a typical extrusion process. However, the mixing paste used for the extrusion process contains 15˜20% water and thus should be very carefully dried for a long period of time. When the drying process is performed for a short period of time, internal stress occurs and thus the ceramic molded body may crack. Also, it is difficult to vary the shape of the produced ceramic molded body.

### SUMMARY OF THE INVENTION

Accordingly, the present invention has been made keeping in mind the problems encountered in the related art and the present invention intends to provide a fuel cell including a support having a mesh structure, which facilitates the collection of current and is lightweight.

An aspect of the present invention provides a fuel cell, including a support having a mesh structure, an anode layer formed on an outer surface of the support, an electrolyte layer formed on an outer surface of the anode layer, and a cathode layer formed on an outer surface of the electrolyte layer.

In this aspect, the fuel cell may further include a metal powder coating layer formed between the support and the anode layer.

In this aspect, the support may be a single body support comprising a plurality of tubular supports juxtaposed in parallel.

As such, the single body support may further include a connector for connecting the plurality of tubular supports in parallel.

In this aspect, the mesh structure of the support may have an aperture of a quadrangular shape or a circular shape.

In this aspect, the support may be formed by superimposing one to ten mesh structures one on another.

In this aspect, the mesh structure of the support may have a cross-section of a circular shape, an elongated circular shape, a delta shape, a semicircular shape or a trapezoidal shape.

In this aspect, the mesh structure of the support may be made of a conductive metal.

As such, the conductive metal may be selected from the group consisting of iron, copper, aluminum, nickel, chromium, alloys thereof and combinations thereof.

Another aspect of the present invention provides a fuel cell, including a support having a mesh structure, a cathode layer formed on an outer surface of the support, an electrolyte layer formed on an outer surface of the cathode layer, and an anode layer formed on an outer surface of the electrolyte layer.

In this aspect, the fuel cell may further include a metal powder coating layer formed between the support and the cathode layer.

In this aspect, the support may be a single body support including a plurality of tubular supports juxtaposed in parallel.

As such, the single body support may further include a connector for connecting the plurality of tubular supports in parallel.

In this aspect, the mesh structure of the support may have an aperture of a to quadrangular shape or a circular shape.

In this aspect, the support may be formed by superimposing one to ten mesh structures one on another.

In this aspect, the mesh structure of the support may have a cross-section of a circular shape, an elongated circular shape, a delta shape, a semicircular shape or a trapezoidal shape.

In this aspect, the mesh structure of the support may be made of a conductive metal.

As such, the conductive metal may be selected from the group consisting of iron, copper, aluminum, nickel, chromium, alloys thereof and combinations thereof.

### BRIEF DESCRIPTION OF THE DRAWINGS

The features and advantages of the present invention will be more clearly understood from the following detailed description taken in conjunction with the accompanying drawings, in which:

FIG. 1 is a view showing the operating principle behind a fuel cell;

FIG. 2 is a cross-sectional view showing a fuel cell including a support having a mesh structure according to a first embodiment of the present invention;

FIGS. 3A and 3B are perspective views showing the mesh structure having apertures of various shapes;

FIG. 4 is a perspective view showing mesh structures which are superimposed one on another;

FIGS. 5A to 5D are perspective views showing the mesh structure having various cross-sectional shapes;

FIG. 6 is a cross-sectional view showing a fuel cell including a support having a to mesh structure according to a second embodiment of the present invention;

FIGS. 7A and 7B are cross-sectional views showing a fuel cell including a support having a mesh structure according to a third embodiment of the present invention;

FIGS. 8A and 8B are perspective views showing a delta shaped mesh structure having variously shaped apertures;

FIGS. 9A and 9B are perspective views showing a semicircular shaped mesh structure having variously shaped apertures;

FIGS. 10A and 10B are perspective views showing a trapezoidal shaped mesh structure having variously shaped apertures;

FIG. 11A is a perspective view showing a delta shaped mesh structure;

FIG. 11B A is a perspective view showing a delta shaped mesh structure having connectors;

FIG. 12A is a perspective view showing a semicircular shaped mesh structure;

FIG. 12B is a perspective view showing a semicircular shaped mesh structure having connectors;

FIG. 13A is a perspective view showing a trapezoidal shaped mesh structure;

FIG. 13B is a perspective view showing a trapezoidal shaped mesh structure having connectors;

FIG. 14 is a perspective view showing mesh structures which are superimposed one on another; and

FIGS. 15A and 15B are cross-sectional views showing a fuel cell including a support having a mesh structure according to a fourth embodiment of the present invention.

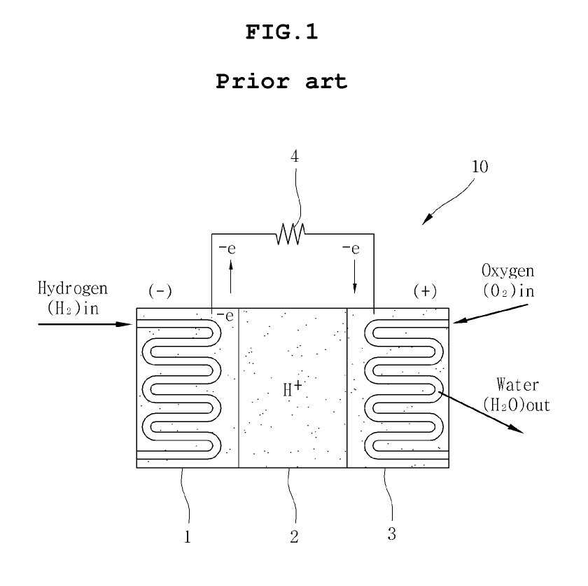

### DESCRIPTION OF SPECIFIC EMBODIMENTS

Hereinafter, a detailed description will be given of embodiments of the present invention with reference to the accompanying drawings. Throughout the drawings, the same reference numerals refer to the same or similar elements, and redundant descriptions are omitted. In the description, in the case where known techniques pertaining to the present invention are regarded as unnecessary because they make the characteristics of the invention unclear and also for the sake of description, the detailed descriptions thereof may be omitted.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

Conventionally, an SOFC is supported using a self-standing electrolyte membrane, an anode, a cathode or the like. In the present invention, a fuel cell includes an additional support, in which the support is provided in the form of a mesh structure 110 or a single body support 300 obtained by connecting a plurality of tubular supports 360, and is thus apparently different in terms of configuration and shape from the conventional supporting method.

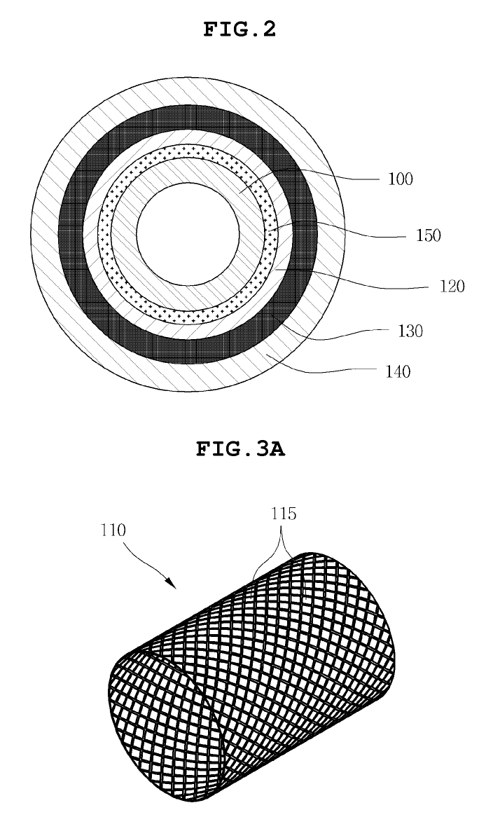

FIG. 2 is a cross-sectional view showing a fuel cell including a support having a mesh structure according to a first embodiment of the present invention. Below, the fuel cell according to the present embodiment is described with reference to the above drawing.

As shown in FIG. 2, the fuel cell according to the present embodiment includes a support 100 having a mesh structure 110, an anode layer 120 formed on an outer surface of the support 100, an electrolyte layer 130 formed on an outer surface of the anode layer 120, and a cathode layer 140 formed on an outer surface of the electrolyte layer 130. Also, to in order to supplement the support 100 having the mesh structure 110, the fuel cell may further include a metal powder coating layer 150 formed between the support 100 and the anode layer 120.

To produce current using the fuel cell, fuel should be supplied to the anode layer 120, and air should be supplied to the cathode layer 140. The fuel cell according to the present embodiment includes the anode layer 120 formed therein and the cathode layer 140 formed on the outermost portion thereof. Thus, the anode layer 120 receives fuel through the support 100, and the cathode layer 140 receives air from the outside. As such, the support 100 should be imparted with gas permeability so that fuel is supplied to the anode layer 120.

In the present invention, the support 100 having the mesh structure 110 is employed, thus simultaneously supporting the anode layer 120, the electrolyte layer 130, and the cathode layer 140 and transferring fuel such as hydrogen supplied to the inside of the support 100 to the anode layer 120 around the support 100.

Also, the mesh structure 110 may be made of a conductive metal so that the support 100 performs a current collection function. The mesh structure 110 may be made of a material selected from the group consisting of iron, copper, aluminum, nickel, chromium, alloys thereof and combinations thereof, having high conductivity and durability. When the support 100 is made of a conductive metal, there is no need to provide an additional current collector in the fuel cell, thus reducing the manufacturing process and the manufacturing cost. Also, because the support 100 is metal, bonding to a manifold becomes easy and gas may be prevented from leaking.

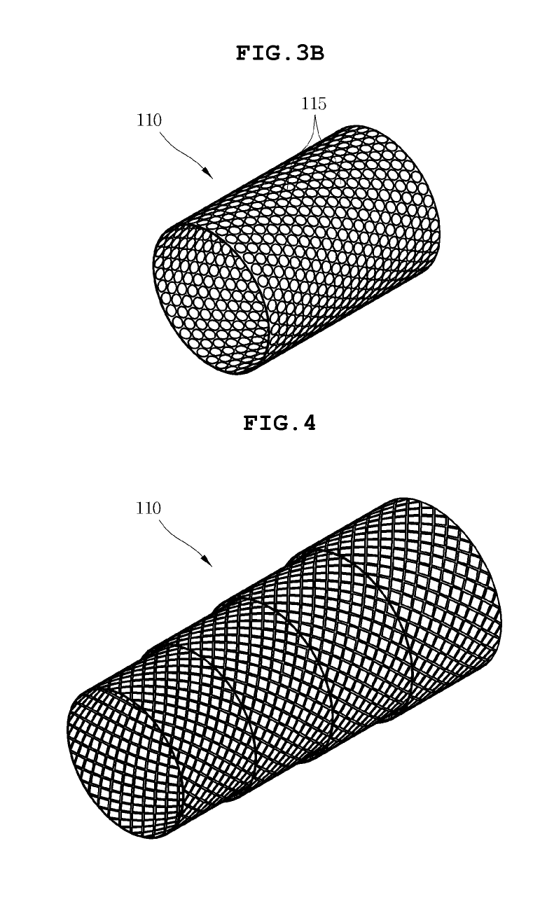

As shown in FIGS. 3A and 3B, the apertures 115 of the mesh structure 110 of the support 100 may have a quadrangular shape or a circular shape. Generally, in the case where the mesh structure 110 is knitted using fine metal wires, the apertures 115 thereof are formed in a quadrangular shape. On the other hand, in the case where the mesh structure 110 is manufactured by subjecting a tubular structure to fine hole processing such as discharge processing using UV laser, YAG laser or spark discharge, the apertures 115 thereof may be formed in a circular shape. These methods are merely illustrative, and other methods may be used as long as the final shape of the apertures 115 of the mesh structure 110 is quadrangular or circular, which will also be incorporated in the scope of the present invention.

The diameter of the apertures 115 of the mesh structure 110 may be set to 1˜10 μM in consideration of the fuel permeability or the component of the anode layer 120 around the mesh structure 110. However, the diameter thereof is not essentially limited to the above numerical values. Alternatively, a mesh structure 110 having apertures of a diameter of tens to hundreds of μM may be manufactured, and then may pass gas therethrough while maintaining its supporting force through formation of a metal powder coating layer 150 or by superimposing mesh structures 110 one on another.

As shown in FIG. 4, the support may be formed by superimposing mesh structures 110 one on another. The number of mesh structures 110 may vary depending on designed fuel cell performance, necessary supporting force, and fuel permeability, and may be desirably set to 1˜10 in the present invention.

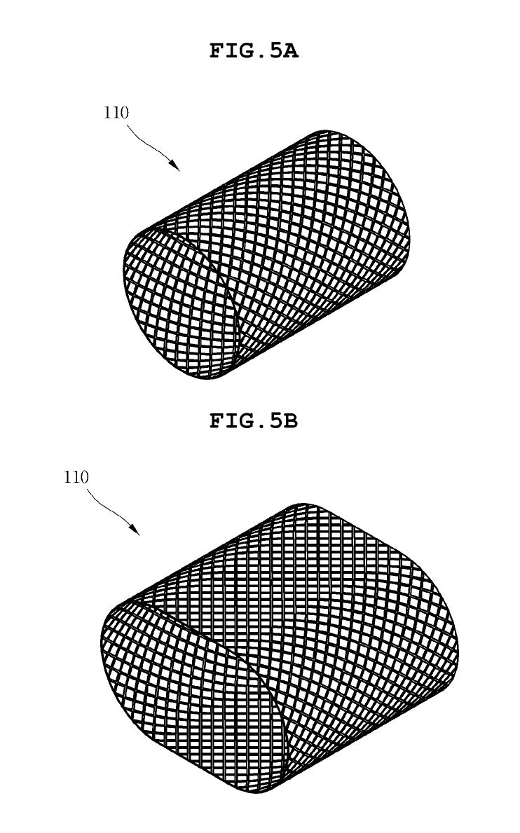

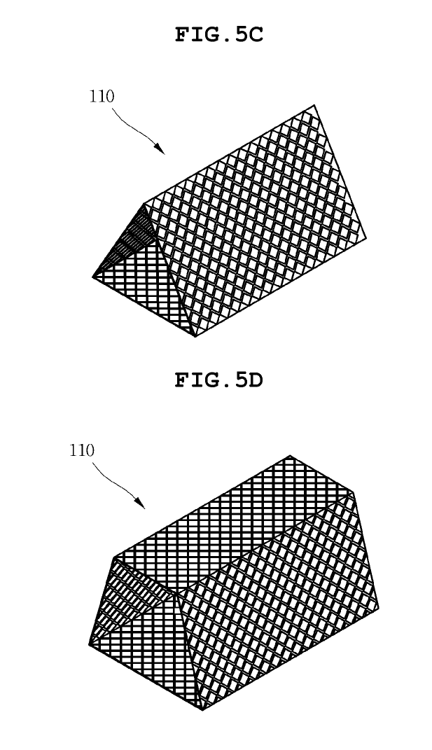

As shown in FIGS. 5A to 5D, the cross-sectional shape of the mesh structure 110 of the support 100 may have a circular shape (FIG. 5A), an elongated circular shape (FIG. 5B), a delta shape (FIG. 5C) or a trapezoidal shape (FIG. 5D). Because the support 100 is formed with the mesh structure 110, it may be easily molded unlike a ceramic support 100.

Thus, a fuel cell having any shape appropriate for its end use may be manufactured, and the size thereof may be increased, if needed.

The metal powder coating layer 150 functions to more stably support the anode layer 120, and is disposed between the support 100 and the anode layer 120. The metal powder coating layer 150 is formed by coating the support 100 with metal powder using spraying or dipping. The metal powder coating layer 150 should be porous so as to impart gas permeability and should have a size able to coat the apertures 115 of the mesh structure 110. For this reason, the diameter of the metal powder may be set to range from hundreds of nm to ones of μm. Furthermore, the metal powder coating layer 150 may be formed of a conductive metal as in the mesh structure 110, thus further increasing the current collection efficiency of the fuel cell.

Depending on the needs, the mesh structures 110 may be superimposed one on another and then the metal powder coating layer 150 may be formed, thus obtaining the desired supporting force and gas permeability.

The anode layer 120 is formed on the outer surface of the support 100. In the case where the metal powder coating layer 150 is formed, the anode layer 120 is formed on the outer surface of the metal powder coating layer 150. The anode layer 120 receives fuel passed through the support 100 thus producing current. The current thus produced is collected by the support 100 made of conductive metal so that electrical energy is fed to an external circuit. The anode layer 120 may be formed by applying NiO-YSZ (Yttria stabilized Zirconia) on the outer surface of the support 100 or the metal powder coating layer 150 through slip coating or plasma spray coating and then heating it to 1200˜1300° C.

The electrolyte layer 130 is formed on the outer surface of the anode layer 120. The electrolyte layer 130 does not pass electrons therethrough, and transfers only the protons to the cathode layer 140 upon use of hydrogen as fuel. The electrolyte layer 130 may be formed by applying YSZ (Yttria stabilized Zirconia) or ScSZ (Scandium stabilized Zirconia), GDC or LDC on the outer surface of the anode layer 120 through slip coating or plasma spray coating and then sintering it at 1300˜1500° C.

Also, the cathode layer 140 is formed on the outer surface of the electrolyte layer 130. In the cathode layer 140, the protons supplied from the electrolyte layer 130 and the electrons passed through the external circuit are combined with oxygen in the air, thus producing water. The cathode layer 140 may be formed by applying LSM (Strontium doped Lanthanum Manganite) or LSCF (La,Sr)(Co,Fe)O₃) through slip coating or plasma spray coating and then sintering it to 1200˜1300° C.

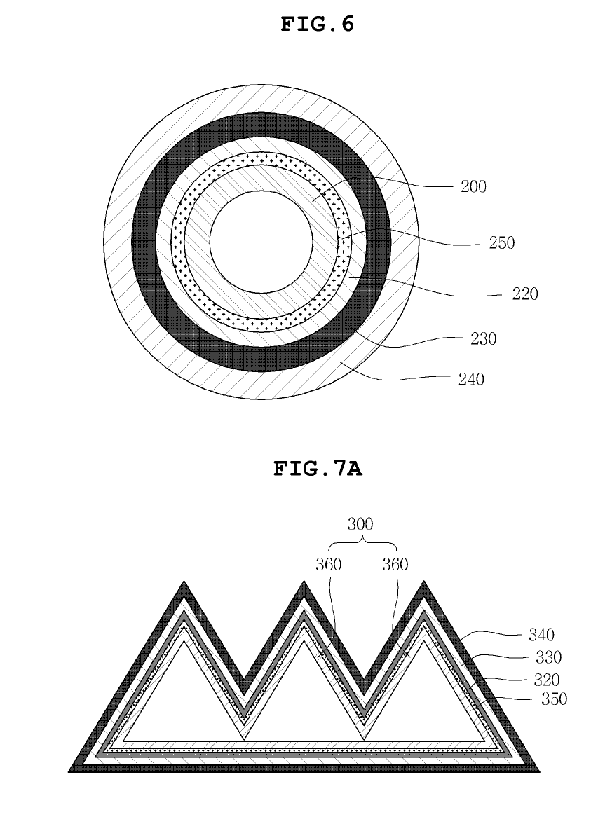

FIG. 6 is a cross-sectional view showing a fuel cell including a support having a mesh structure according to a second embodiment of the present invention. The major difference between the present embodiment and the first embodiment is the position at which the anode layer and the cathode layer are formed. Below, the description the same as that of the first embodiment is omitted, and portions of the description which are different are provided.

As shown in FIG. 6, the fuel cell according to the present embodiment includes a support 200 having a mesh structure 110, a cathode layer 220 formed on an outer surface of the support 200, an electrolyte layer 230 formed on an outer surface of the cathode layer 220, and an anode layer 240 formed on an outer surface of the electrolyte layer 230. Also, to supplement the support 200 having the mesh structure 110, the fuel cell may further include a metal powder coating layer 250 disposed between the support 200 and the cathode layer 220. When comparing the fuel cell according to the present embodiment with the fuel cell according to the first embodiment, the position at which the cathode layer 140, 220 and the anode layer 120, 240 are formed can be seen to be reversed.

The fuel cell according to the present embodiment includes the cathode layer 220 formed therein and the anode layer 240 formed on the outermost portion thereof. Thus, the cathode layer 220 receives air through the support 200, and the anode layer 240 receives fuel from the outside. As such, as mentioned above, the support 200 should be imparted with gas permeability to supply air to the cathode layer 120.

The support 200 has the mesh structure 110 in order to impart gas permeability as in the first embodiment. The support 200 may transfer air to the cathode layer 220 through the mesh structure 110. As such, the diameter of the apertures 115 of the mesh structure 110 may be set in consideration of the gas permeability or the component of the cathode layer 220 around the mesh structure 110. Also, the metal powder coating layer 250 may be formed between the support 200 and the cathode layer 220 so as to more stably support the cathode layer 220.

As shown in FIGS. 3A and 3B, the apertures 115 of the mesh structure 110 may have a quadrangular shape or a circular shape. As shown in FIGS. 5A to 5D, the mesh structure 110 may have a cross-section of a circular shape, an elongated circular shape, a delta shape or a trapezoidal shape. As shown in FIG. 4, the support 200 may be formed by superimposing one to ten mesh structures 110 one on another.

The cathode layer 220 is formed on the outer surface of the support 200 or the metal powder coating layer 250, and the electrolyte layer 230 is formed on the outer surface of the cathode layer 220. The anode layer 240 is formed on the outer surface of the electrolyte layer 230. The cathode layer 220, the electrolyte layer 230 and the anode layer 240 are formed in the same manner as in the first embodiment.

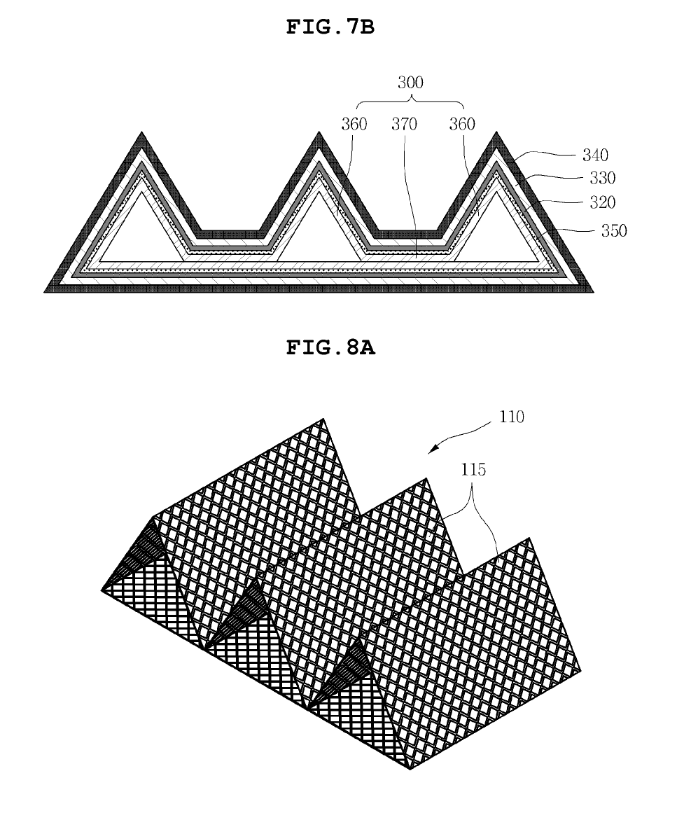

FIGS. 7A and 7B are cross-sectional views showing a fuel cell including a support having a mesh structure according to a third embodiment of the present invention. Below, the fuel cell according to the present embodiment is specified with reference to the above drawings.

As shown in FIGS. 7A and 7B, the fuel cell according to the present embodiment includes a single body support 300 having a mesh structure 110 and including a plurality of tubular supports 360 juxtaposed in parallel, an anode layer 320 formed on an outer surface of the single body support 300, an electrolyte layer 330 formed on an outer surface of the anode layer 320, and a cathode layer 340 formed on an outer surface of the to electrolyte layer 330. Also, the fuel cell may further include a metal powder coating layer 350 between the single body support 300 and the anode layer 320 in order to supplement the single body support 300 having the mesh structure 110. The single body support 300 may further include connectors 370 for connecting the plurality of tubular supports 360 in parallel.

In order to produce current using the fuel cell, fuel should be transferred to the anode layer 320, and air should be supplied to the cathode layer 340. The fuel cell according to the present embodiment includes the anode layer 320 formed therein and the cathode layer 340 formed on the outermost portion thereof. Thus, the anode layer 320 receives fuel through the single body support 300, and the cathode layer 340 receives air from the outside. As such, the single body support 100 should be imparted with gas permeability so as to supply fuel to the anode layer 320.

In the present invention, the single body support 300 having the mesh structure 110 is employed, thus simultaneously supporting the anode layer 320, the electrolyte layer 330, and the cathode layer 340 and transferring fuel such as hydrogen supplied to the inside of the single body support 300 to the anode layer 320 around the single body support 300.

The single body support 300 includes the plurality of tubular supports 360 juxtaposed in parallel. When the anode layer 320, the electrolyte layer 330 and the cathode layer 340 are formed on the outer surface of the single body support 300, a plurality of unit cells is provided in the form of being supported by one support and thus its configuration is stable and a stacking process thereof becomes simple.

Also, the mesh structure 110 may be formed of a conductive metal so that the single body support 300 performs a current collection function. Specifically, the mesh structure 110 may be made of a material selected from the group consisting of iron, copper, aluminum, nickel, chromium, alloys thereof and combinations thereof, having to high conductivity and durability. When the single body support 300 is made of a conductive metal, there is no need to provide an additional current collector in the fuel cell, thus reducing the manufacturing process of the fuel cell and the manufacturing cost. Also, because the single body support 300 is metal, bonding to a manifold becomes easy and gas may be prevented from leaking.

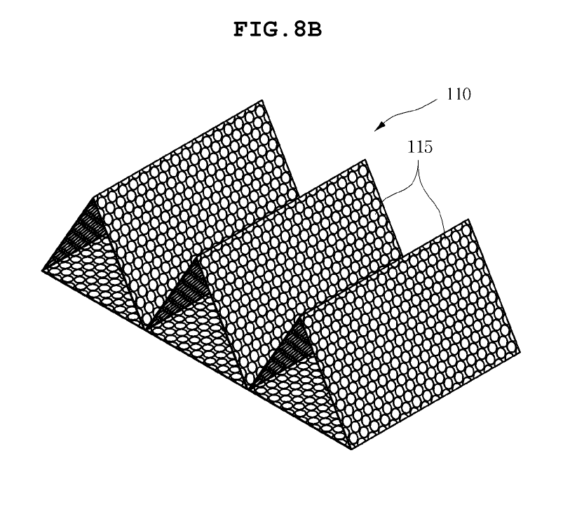

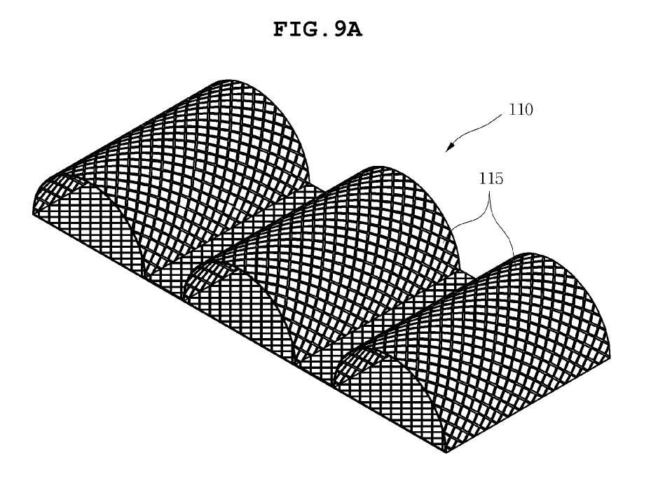

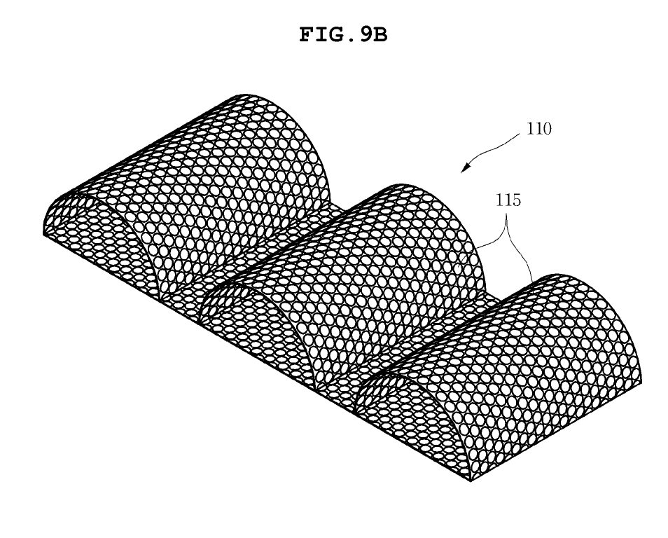

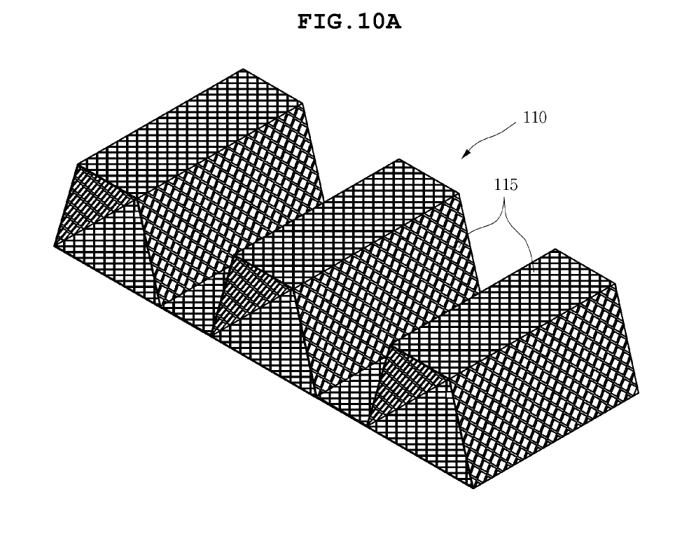

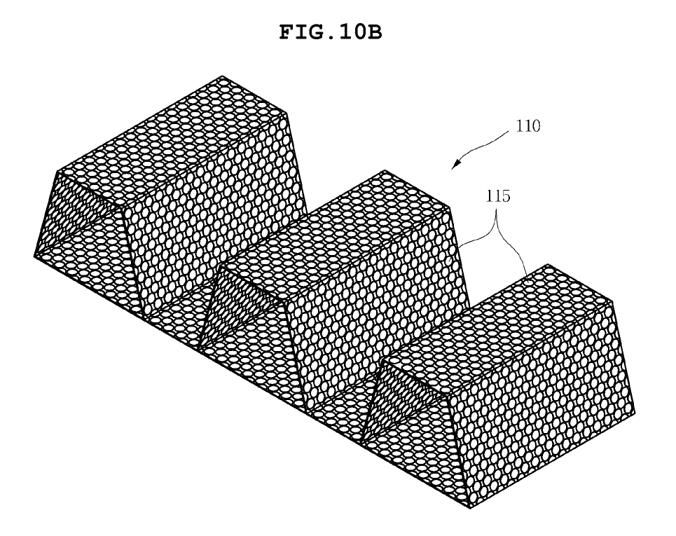

FIGS. 8A and 8B are perspective views showing a delta shaped mesh structure having various aperture shapes, FIGS. 9A and 9B are perspective views showing a semicircular shaped mesh structure having various aperture shapes, and FIGS. 10A and 10B are perspective views showing a trapezoidal shaped mesh structure having various aperture shapes.

As shown in FIGS. 8A, 8B, 9A, 9B, 10A and 10B, the apertures 115 of the mesh structure 110 of the single body support 300 may have a quadrangular shape or a circular shape. Generally, in the case where the mesh structure 110 is knitted using fine metal wires, the apertures 115 thereof are formed in a quadrangular shape. On the other hand, in the case where the mesh structure 110 is manufactured by subjecting a tubular structure to fine hole processing such as discharge processing using UV laser, YAG laser or spark discharge, the apertures 115 thereof may be formed in a circular shape. These methods are merely illustrative, and other methods may be used as long as the final shape of the apertures 115 of the mesh structure 110 is quadrangular or circular, which will also be incorporated in the scope of the present invention.

The diameter of the apertures 115 of the mesh structure 110 may be set to 1˜10 μm taking into consideration the fuel permeability or the component of the anode layer 320 around the mesh structure 110. However, the diameter thereof is not essentially limited to the above numerical values. Alternatively, a mesh structure 110 having apertures of a diameter of tens to hundreds of μm may be manufactured, and then may pass gas therethrough while maintaining its electrode supporting force through formation of a metal powder coating layer 350 or by superimposing mesh structures 110 one on another.

As shown in FIGS. 8A, 8B, 9A, 9B, 10A and 10B, the cross-sectional shape of the mesh structure 110 of the single body support 300 may have a delta shape, a semicircular shape or a trapezoidal shape. Because the single body support 300 is formed with the mesh structure 110, it may be easily molded unlike the ceramic support 100. Thus, a fuel cell having any shape appropriate for its end use may be manufactured, and the size thereof may be increased, if needed.

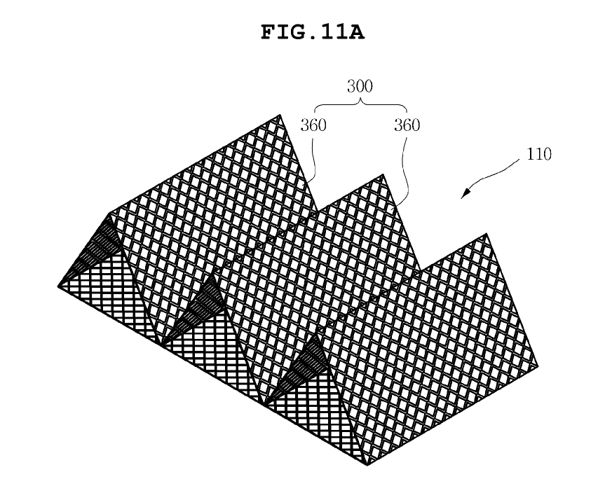

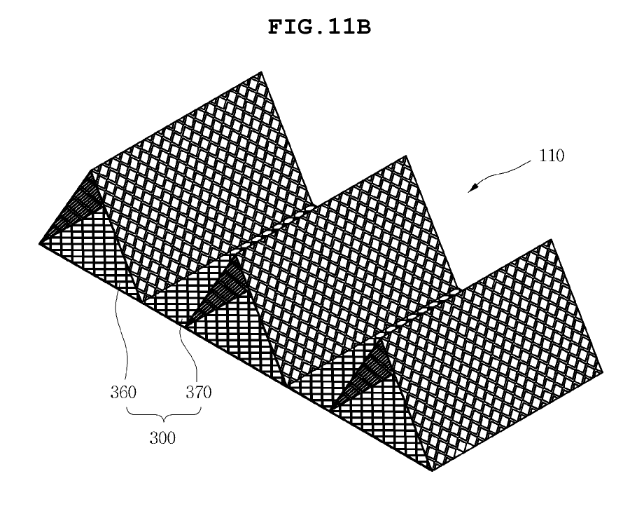

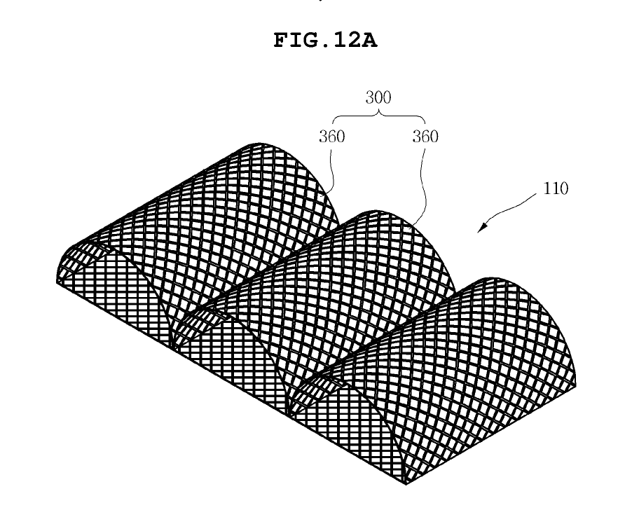

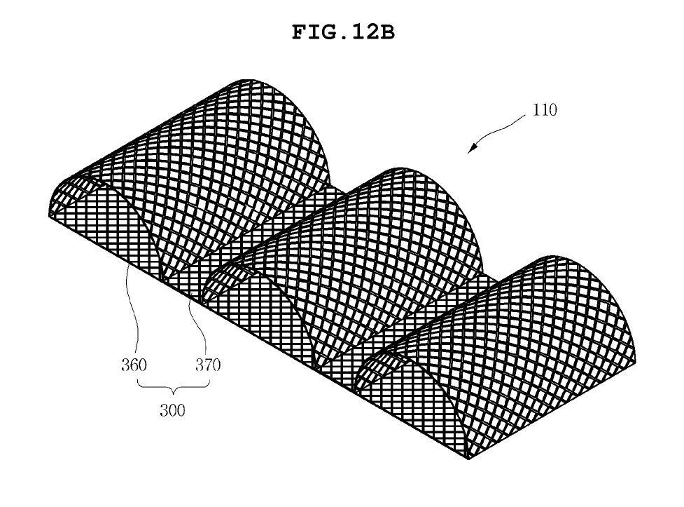

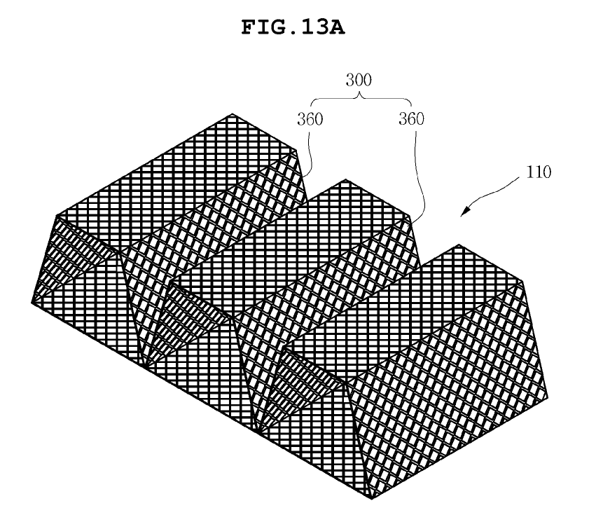

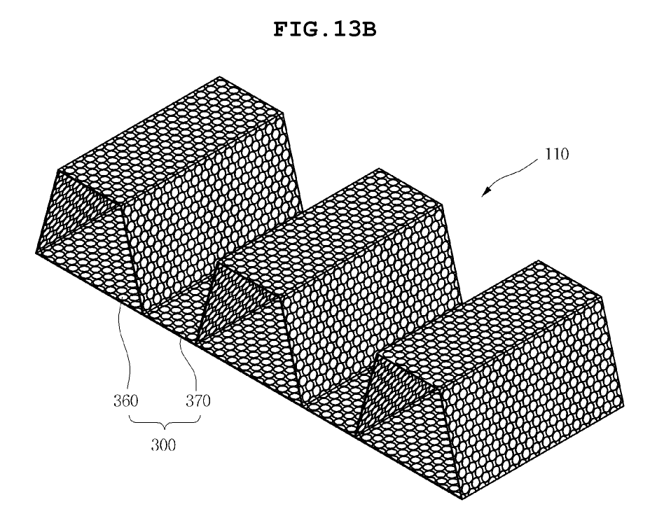

FIGS. 11A, 11B, 12A, 12B, 13A and 13B are perspective views showing the mesh structure having a cross-section of a delta shape, a semicircular shape or a trapezoidal shape, with or without connectors.

As shown in FIGS. 11A, 11B, 12A, 12B, 13A and 13B, the single body support 300 may further include connectors 370 for connecting the plurality of tubular supports 360 in parallel. The connectors 370 function to connect the tubular supports 360. Although this element is not essential for production of current, it may be further included in the single body support 300 in consideration of stability or reliability of the single body support 300 or a subsequent stacking process. Although the connectors 370 may be manufactured separately from the tubular supports 360 and then connected to the tubular supports 360, they may be desirably provided in the form of the mesh structure 110 along with the tubular supports 360.

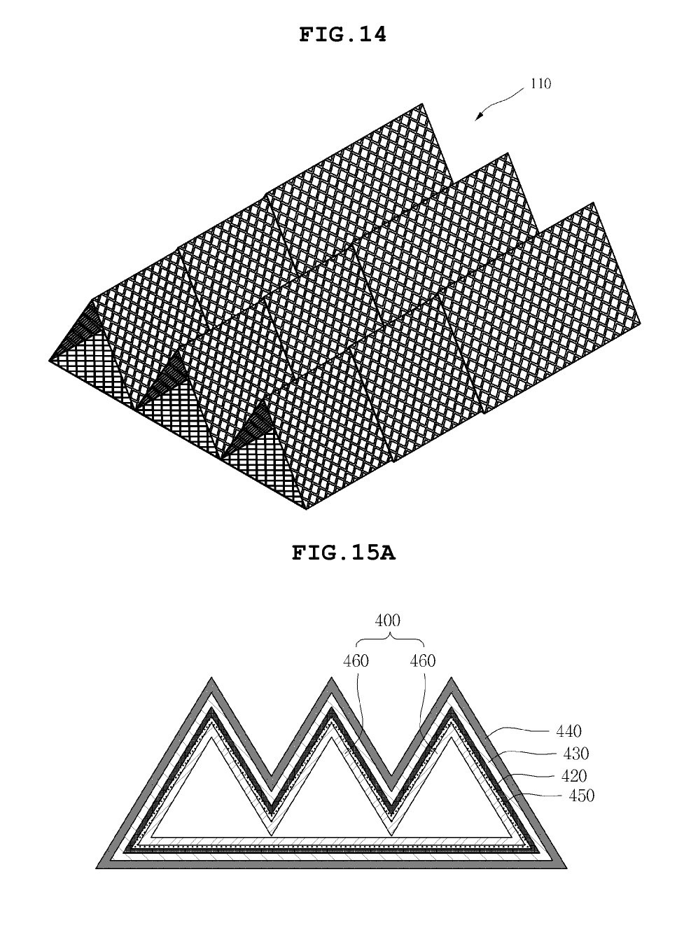

FIG. 14 is a perspective view showing mesh structures superimposed one on another. As shown in FIG. 14, the single body support 300 may be formed by superimposing the mesh structures 110 one on another. The number of mesh structures 110 may vary depending on designed fuel cell performance, necessary supporting force and fuel permeability, and may be desirably set to 1-10 in the present invention.

The metal powder coating layer 350 plays a role in more stably supporting the to anode layer 320, and is disposed between the single body support 300 and the anode layer 320. The metal powder coating layer 350 is formed by coating the single body support 300 with metal powder using spraying or dipping. The metal powder coating layer 350 should be porous so as to impart gas permeability and should have a size able to coat the apertures 115 of the mesh structure 110. For this reason, the diameter of the metal powder may be set to the range from hundreds of nm to ones of μm. Furthermore, the metal powder coating layer 350 is formed of a conductive metal as in the mesh structure 110, thus further increasing the current collection efficiency of the fuel cell.

Also, depending on the needs, the mesh structures 110 may be superimposed one on another and then the metal powder coating layer 350 may be formed, thus obtaining the desired supporting force and gas permeability.

Below, the operation and formation of the anode layer 320, the electrolyte layer and the cathode layer 340 are described.

The anode layer 320 is formed on the outer surface of the single body support 300. In the case where the metal powder coating layer 350 is formed, the anode layer 320 is formed on the outer surface of the metal powder coating layer 350. The anode layer 320 receives fuel passed through the single body support 300 thus producing current. The current thus produced is collected by the single body support 300 made of conductive metal so that electrical energy is fed to an external circuit. The anode layer 320 may be formed by applying NiO-YSZ on the outer surface of the single body support 300 or the metal powder coating layer 350 through slip coating or plasma spray coating and then heating it to 1200˜1300° C.

The electrolyte layer 330 is formed on the outer surface of the anode layer 320. The electrolyte layer 330 does not pass electrons therethrough, and transfers only the protons to the cathode layer 340 upon use of hydrogen as fuel. The electrolyte layer 330 may be formed by applying YSZ or ScSZ, GDC or LDC on the outer surface of the anode to layer 320 through slip coating or plasma spray coating and then sintering it at 1300˜1500° C.

Also, the cathode layer 340 is formed on the outer surface of the electrolyte layer 330. In the cathode layer 340, the protons supplied from the electrolyte layer 330 and the electrons transferred through the external circuit are combined with oxygen in the air, thus producing water. The cathode layer 340 may be formed by applying LSM or LSCF through slip coating or plasma spray coating and then sintering it at 1200˜1300° C.

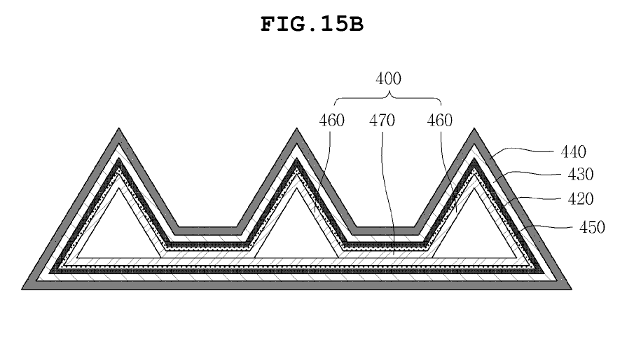

FIGS. 15A and 15B are cross-sectional views showing a fuel cell including a support having a mesh structure according to a fourth embodiment of the present invention. The major difference between the present embodiment and the third embodiment is the position at which the anode layer and the cathode layer are formed. Below, the description the same as that of the third embodiment is omitted, and portions of the description which are different are provided.

As shown in FIGS. 15A and 15B, the fuel cell according to the present embodiment includes a single body support 400 having a mesh structure 110 and including a plurality of tubular supports 460 juxtaposed in parallel, a cathode layer 420 formed on an outer surface of the single body support 400, an electrolyte layer 430 formed on an outer surface of the cathode layer 420, and an anode layer 440 formed on an outer surface of the electrolyte layer 430. Also, in order to support the single body support 400 having the mesh structure 110, the fuel cell may further include a metal powder coating layer 450 formed between the single body support 400 and the cathode layer 420. The single body support 400 may further include connectors 470 for connecting the plurality of tubular supports 460 in parallel.

When comparing the fuel cell according to the present embodiment with the fuel cell according to the third embodiment, the position at which the cathode layer 420 and the to anode layer 440 are formed can be seen to be reversed.

The fuel cell according to the present embodiment includes the cathode layer 420 formed therein and the anode layer 440 formed on the outermost portion thereof. Thus, the cathode layer 420 receives air through the single body support 400, and the anode layer 440 receives fuel from the outside. As such, as mentioned above, the single body support 400 should have gas permeability to supply air to the cathode layer 420.

The single body support 400 has the mesh structure 110 in order to impart gas permeability as in the third embodiment. The single body support 400 may transfer air to the cathode layer 420 through the mesh structure 110. As such, the diameter of the apertures 115 of the mesh structure 110 may be set in consideration of the gas permeability or the component of the cathode layer 420 around the mesh structure 110. Also, the metal powder coating layer 450 may be formed between the single body support 400 and the cathode layer 420 to more stably support the cathode layer 420.

As shown in FIGS. 8A, 8B, 9A, 9B, 10A and 10B, the apertures 115 of the mesh structure 110 may have a quadrangular shape or a circular shape. The mesh structure 110 may have a cross-section which makes a delta shape, a semicircular shape or a trapezoidal shape. As shown in FIG. 14, the single body support 400 may be formed by superimposing one to ten mesh structures 110 one on another.

The cathode layer 420 is formed on the outer surface of the single body support 400 or the metal powder coating layer 450, and the electrolyte layer 430 is formed on the outer surface of the cathode layer 420. The anode layer 440 is formed on the outer surface of the electrolyte layer 430. The cathode layer 420, the electrolyte layer 430 and the anode layer 440 are formed in the same manner as in the third embodiment.

As described hereinbefore, the present invention provides a fuel cell including a support having a mesh structure. According to the present invention, an SOFC includes a single body support having a mesh structure, thus further increasing durability and to reliability compared to when using a conventional ceramic support. Also, even when this support is formed to be thinner than the conventional ceramic support, it can maintain its support strength, thus reducing the thickness and weight of a fuel cell stack.

According to the present invention, the single body support is made of a conductive metal and thus can be used as a current collector in lieu of metal foam. Also, the single body support has higher current collection efficiency compared to when using a conventional current collection method. Moreover, because this support is provided in the form of a single body, a process for connecting current collectors between unit cells is obviated, thus reducing the manufacturing process and the manufacturing cost.

According to the present invention, the single body support is made of metal and can be hermetically sealed through welding upon bonding to a manifold.

According to the present invention, the single body support having the mesh structure can be provided in various shapes, thus facilitating the molding of the fuel cell. Taking into consideration fuel cell fields, cell performance, manufacturing cost, etc., the fuel cell can be variously shaped, and an SOFC having a large capacity can be manufactured through scale-up.

Although the embodiments of the present invention regarding the fuel cell including the support having the mesh structure have been disclosed for illustrative purposes, those skilled in the art will appreciate that various modifications, additions and substitutions are possible, without departing from the scope and spirit of the invention as disclosed in the accompanying claims. In particular, the embodiments of the present invention are described based on the SOFC, but are not limited thereto and may be applied to any fuel cell using a support. Accordingly, such modifications, additions and substitutions should also be understood as falling within the scope of the present invention.

What is claimed is:

1. A fuel cell, comprising:
a support having a mesh structure;
an anode layer formed on an outer surface of the support;
an electrolyte layer formed on an outer surface of the anode layer; and
a cathode layer formed on an outer surface of the electrolyte layer.

2. The fuel cell as set forth in claim 1, further comprising a metal powder coating to layer formed between the support and the anode layer.

3. The fuel cell as set forth in claim 1, wherein the support is a single body support comprising a plurality of tubular supports juxtaposed in parallel.

4. The fuel cell as set forth in claim 3, wherein the single body support further comprises a connector for connecting the plurality of tubular supports in parallel.

5. The fuel cell as set forth in claim 1, wherein the mesh structure of the support has an aperture of a quadrangular shape or a circular shape.

6. The fuel cell as set forth in claim 1, wherein the support is formed by superimposing one to ten mesh structures one on another.

7. The fuel cell as set forth in claim 1, wherein the mesh structure of the support has a cross-section of a circular shape, an elongated circular shape, a delta shape, a semicircular shape or a trapezoidal shape.

8. The fuel cell as set forth in claim 1, wherein the mesh structure of the support is made of a conductive metal.

9. The fuel cell as set forth in claim 8, wherein the conductive metal is selected from the group consisting of iron, copper, aluminum, nickel, chromium, alloys thereof and combinations thereof.

10. A fuel cell, comprising:
a support having a mesh structure;
a cathode layer formed on an outer surface of the support;
an electrolyte layer formed on an outer surface of the cathode layer; and
an anode layer formed on an outer surface of the electrolyte layer.

11. The fuel cell as set forth in claim 10, further comprising a metal powder coating layer formed between the support and the cathode layer.

12. The fuel cell as set forth in claim 10, wherein the support is a single body support comprising a plurality of tubular supports juxtaposed in parallel.

13. The fuel cell as set forth in claim 12, wherein the single body support further comprises a connector for connecting the plurality of tubular supports in parallel.

14. The fuel cell as set forth in claim 10, wherein the mesh structure of the support has an aperture of a quadrangular shape or a circular shape.

15. The fuel cell as set forth in claim 10, wherein the support is formed by superimposing one to ten mesh structures one on another.

16. The fuel cell as set forth in claim 10, wherein the mesh structure of the support has a cross-section of a circular shape, an elongated circular shape, a delta shape, a semicircular shape or a trapezoidal shape.

17. The fuel cell as set forth in claim 10, wherein the mesh structure of the support is made of a conductive metal.

18. The fuel cell as set forth in claim 17, wherein the conductive metal is selected from the group consisting of iron, copper, aluminum, nickel, chromium, alloys thereof and combinations thereof.
